(19) United States
(12) Patent Application Publication
(10) Pub. No.: US 2009/0249265 A1
(43) Pub. Date: Oct. 1, 2009

(54) PRINTED CIRCUIT BOARD DESIGNING APPARATUS AND PRINTED CIRCUIT BOARD DESIGNING METHOD

(75) Inventor: Akira ARATA, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/409,995

(22) Filed: Mar. 24, 2009

(30) Foreign Application Priority Data
Mar. 28, 2008 (JP) 2008-086373

(51) Int. Cl. G06F 17/50

(52) U.S. Cl. 716/4; 716/8

(57) ABSTRACT

A method for designing a printed circuit board includes: determining a distance along a conductive line between an electronic component and a signal source which are mounted on the printed circuit board, the signal source transmitting a signal to the electronic component; calculating a maximum distance for preventing a voltage across the electronic component in a steady state from being superimposed with a reflected signal reflected from at the signal source, the maximum distance being between the electronic component and the signal source, the voltage caused by the signal, and simulating whether an amplitude of a voltage applying across the electronic component is within a given range when the distance is longer than the maximum distance.

### CROSS-REFERENCE TO RELATED APPLICATIONS

This application is based upon and claims the benefit of priority of the prior Japanese Patent Application No. 2008-086373, filed on Mar. 28, 2008, the entire contents of which are incorporated herein by reference.

### FIELD

The embodiment discussed herein relates to a technique applied to designing of an electronic circuit including electronic components mounted thereon.

### BACKGROUND

Printed circuit boards becomes higher and higher in design density as requirements for higher operating frequency of a signal, lower LSI power source voltage, and more compact device are mounting. Since such a high density design increases an amount of noise and reduces noise margin, the problem of transmission noise superimposed on a signal flowing along a wiring line on a printed circuit board becomes pronounced. Here, transmission noise refers to a reflective wave and the like generated due to a difference in impedance of a circuit and superimposed on the signal.

Wiring lines of few thousands to tens of thousands are mounted on the printed circuit board, and whether to implement transmission noise preventive process on each one of the lines is left in practice to guesswork or experience of circuit designers in practice. For this reason, problems arise, for example, huge amounts of time are consumed to extract a wiring line to be analyzed, and erratic operations occur resulting from omission of a wiring line to be analyzed.

Japanese Laid-open Patent Publication No. 2003-216674 discloses a system designing a high-speed signal printed circuit board within a short period of time. The system disclosed in the Patent Publication performs a pre-simulation operation on a location of each component to be mounted on a board in order to determine the component location, performs a post-simulation operation in order to evaluate an optimum value of a terminal resistance and the effect of crosstalk, and then determines actual wiring lines extending between components. In this method, the simulation operation is performed twice, and the pre-simulation operation requires detailed simulation.

### SUMMARY

According to one aspect of an embodiment, there is provided a method for designing a printed circuit board comprising: determining a distance along a conductive line between an electronic component and a signal source which are mounted on the printed circuit board, the signal source transmitting a signal to the electronic component; calculating a maximum distance for preventing a voltage across the electronic component in a steady state from being superimposed with a reflected signal reflected from at the signal source, the maximum distance being between the electronic component and the signal source, the voltage caused by the signal; and simulating whether an amplitude of a voltage applying across the electronic component is within a given range when the distance is longer than the maximum distance.

The object and advantages of the invention will be realized and attained by means of the elements and combinations particularly pointed out in the claims.

It is to be understood that both the foregoing general description and the following detailed description are exemplary and are not restrictive of the invention, as claimed.

### BRIEF DESCRIPTION OF DRAWINGS

FIG. 1 illustrates a flowchart of processing in a printed circuit board designing apparatus according to an embodiment;

FIGS. 2A and 2B illustrate a diagram showing noise generation;

FIGS. 3A and 3B illustrate a diagram showing an overview of a simulation performed by the printed circuit board designing apparatus according to the embodiment;

FIG. 4 illustrates a diagram showing a configuration of the printed circuit board designing apparatus according to the embodiment

FIG. 5 illustrates a flowchart of processing in the printed circuit board designing apparatus according to the embodiment; and

FIG. 6 illustrates a display on screen according to the embodiment.

### DESCRIPTION OF EMBODIMENT

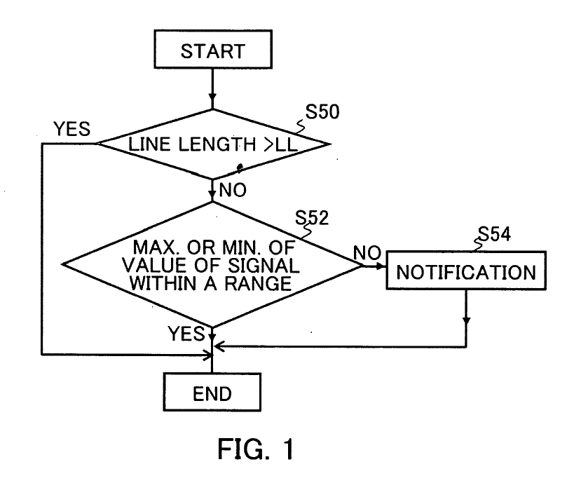

FIG. 1 illustrates an example of process flow according to an embodiment. Whether the transmission noise as a reflected wave of a signal affects the signal at a point where impedance changes is determined in a basic process according to a line length (S50). The line length is one of conductive patterns for coupling electronic components. Next, if the line length is a given length LL or longer, a maximum value and a minimum value of the signal are determined with the transmission noise being superimposed on the signal. It is then determined whether the maximum value is equal to or lower than a maximum permissible value of a component and it is determined whether the minimum value is a minimum permissible value of the component (S52). If it is determined in S52 that the signal with the noise superimposed thereon takes a value out of the permissible range, the line (or the pattern) is displayed to notify a user of line (S54).

The above process is described further in detail.

[Calculation of Line Length in need of Transmission Noise Prevent Process]

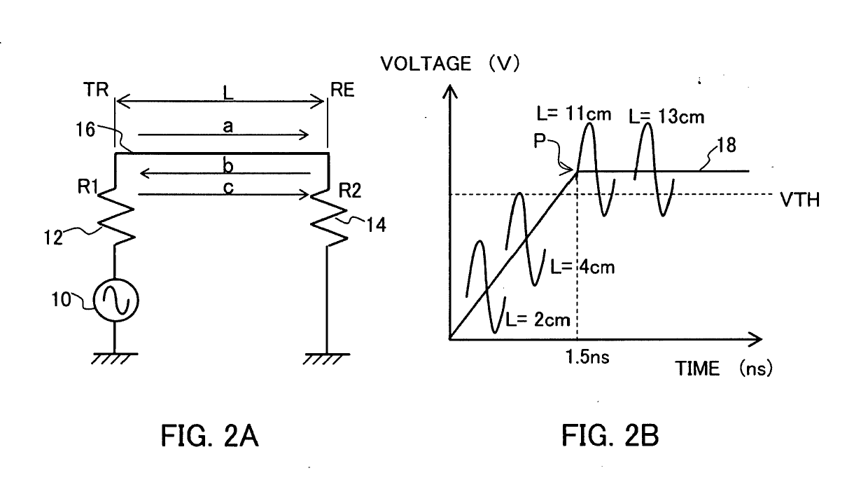

FIG. 2A illustrates an example of components to be mounted on a printed circuit board, and a path line that connects the components by a conductive pattern or the like. If a circuit is modeled as illustrated, a signal output from a transmitter side (TR) travels in a direction of an arrow AA. At the moment the signal reaches a receiver side (RE), a reflected wave is generated because of a difference between an impedance of a line (conductive pattern 16) and an input resistance (R2 14) of the receiver side, and the reflected wave travels in a direction of an arrow BB.

The reflected wave traveling toward the transmitter side causes a reflected wave, in the same manner as the reflected wave takes place at the receiver side, because of a difference between an impedance of the line and an output resistance (R1 12) of the transmitter side, and the generated reflected wave travels in a direction of an arrow CC toward the receiver side, and then received. FIG. 2B illustrates a voltage value applied to an input resistor R2 14 of the receiver side with time elapse, and illustrates that the reflected wave is superimposed on a signal 18. As illustrated in FIG. 2B, the reflected wave reaching the receiver side causes the signal at the receiver side to be distorted. In this way, the reflected wave generated at the receiver side returns to the transmitter side, and then reflected. The reflected wave then reach the receiver side, thereby becoming a factor for noise.

Whether design taking into consideration the transmission noise is required or not is determined depending on the ratio of a rise time (or fall time) of the signal to a time the signal takes to go and return along the line when the signal travels along the line.

The time the signal takes to travel along the line is determined from line constants. If glass epoxy is used for material of a board, the time is usually 7 ns/m or so. In contrast, a rise time of a high-speed gate is about 1.5 ns. A line length L at which the rise time of the signal equals the time the signal takes to go and return along the line (line length L along which a reflected wave reaches near point P in FIG. 2B) with turnaround time=(2×L)×7 ns/m, and the rise time of the signal being 1.5 ns, is

L=1.5 ns/(2×7 ns/m)=11 cm

If a reflected wave with the line length L changed is superimposed onto the signal 18 having no reflected wave superimposed thereon, FIG. 2B illustrates the results. VTH represents a voltage value recognized as a signal at the receiver side, and FIG. 2B illustrates that in the case of the line length of 11 cm or shorter, there is no effect of the reflected wave until the signal settles at VTH or above.

On the other hand, in the case of the line length of 11 cm or longer, the reflected wave is superimposed after the signal rises. The time until a synthesized signal waveform settles at a given value equal to or higher than VTH is extended. Furthermore, since there is a possibility that a peak voltage value rises above a permissible value for electronic components to be connected to the line, the transmission noise prevention process is needed in the case of the line length of 11 cm or longer.

More specifically, let Vo (ns/m) represent time the signal takes to travel along the line, Trf (ns) represent a rise time (fall time) of the signal, and L (m) represent the line length. it is not necessary to consider the transmission noise if the line length L≦Tfr/(2×Vo), and the transmission noise needs to be studied further in detail if the line length L>Trf/(2×Vo).

[Simple Simulation]

If the line length is longer than Trf/(2×Vo) as described above, it determine whether the voltage value of the signal with the transmission noise superimposed thereon is within or out of the permissible range. To perform this determination, a simple simulation described below is performed.

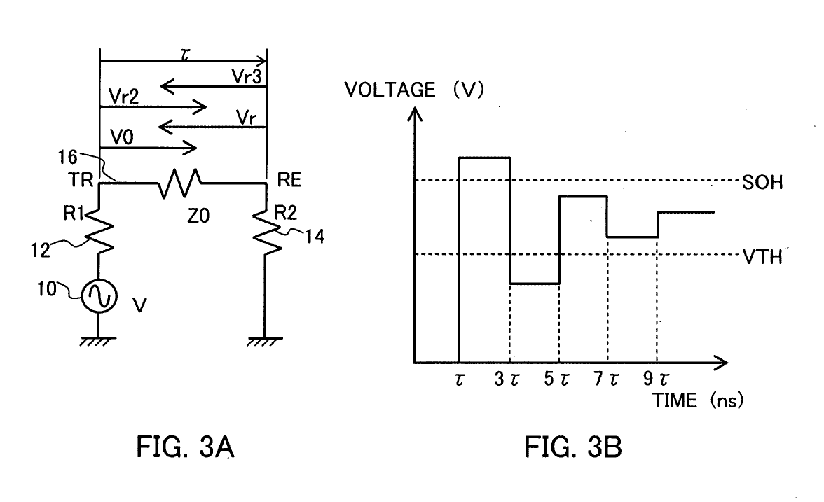

FIG. 3 illustrates the simulation. FIG. 3A is an example of a circuit and FIG. 3B illustrates simulation results.

In FIG. 3A, V0 represents an initial value, Z0 represents characteristic impedance of the line, and τ (nS) represents a time the signal takes to travel from the transmitter side TR to the receiver side RE.

The signal having an amplitude of V0 reaches the receiver side τ after the transmission thereof. A mismatch between the characteristic impedance of the line and an input resistance R2 of the receiver side causes a reflected wave having an amplitude of Vr. The reflected wave then travels to the transmitter side TR, and an impedance mismatch at the transmitter side TR causes a reflected wave having an amplitude of Vr2. This reflected wave causes a reflected wave having an amplitude of Vr3 at the receiver side RE.

The relationship of an output resistance (R1) of the transmitter side TR, the characteristic impedance (Z0) of the line, and the input resistance (R2) of the receiver side RE are related to be as R1<<Z0 (R1 is much smaller than Z0) and R2>>Z0 (R2 is much greater than Z0). The transmission noise input to the receiver side RE tends to converge with time for these relationships. In accordance with the present embodiment, only a voltage value V(τ) at the moment the signal output from the transmitter side TR reaches the receiver side RE, and a voltage value V(3τ) of the reflected wave at the moment the reflected wave returns again to the receiver side RE are calculated as signals input to the receive side RE.

The above V(τ) and V(3τ) are described below.

$$V ( τ ) = V 0 + Vr$$

$$V ( 3 τ ) = V ( τ ) + Vr 2 + Vr 3$$

$$where$$

$$V 0 = \frac{Z 0}{Z 0 + R 1} V$$

$$Vr = \frac{R 2 - Z 0}{R 2 + Z 0} V 0$$

$$Vr 2 = \frac{R 1 - Z 0}{R 1 + Z 0} Vr$$

$$Vr 3 = \frac{R 2 - Z 0}{R 2 + Z 0} Vr 2$$

FIG. 3B diagrammatically illustrates voltages with the V(5τ), V(7τ), and V(9τ) added to V(τ) and V(3τ).

Using the above-described equations, the maximum voltage value and the minimum voltage value of the voltage input to the receiver side RE are determined. It is thus determined whether the maximum voltage value is equal to or lower than the maximum permissible voltage value (SOH) of the component at the receiver side RE, and it is determined whether the minimum voltage value is the minimum permissible voltage value (VTH) of the component. The minimum permissible voltage value is a minimum voltage value the component at the receiver side RE recognizes as a signal.

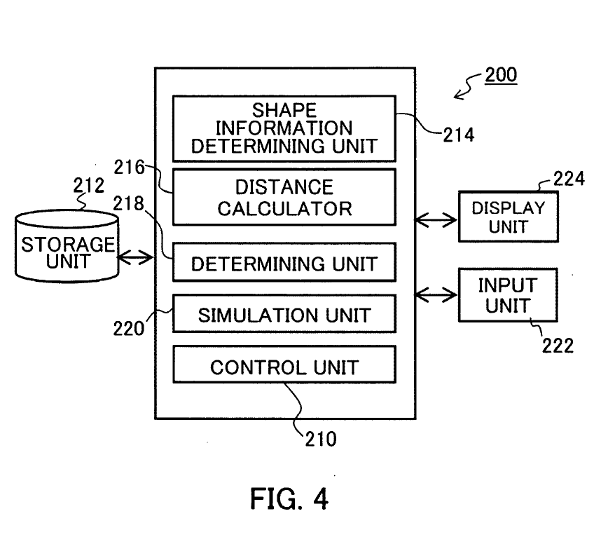

An embodiment of the calculation of the line length in need of the transmission noise prevention step described above and the simple simulation is described with reference to FIGS. 4 through 6.

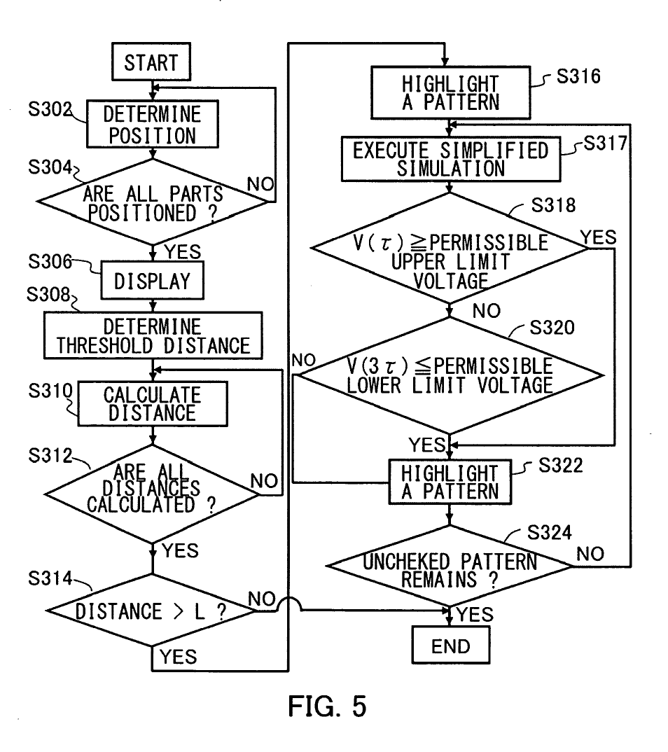

FIG. 4 illustrates a printed circuit board designing apparatus 200 of the embodiment, and FIG. 5 illustrates a process of the printed circuit board designing apparatus 200. As illustrated in FIG. 4, a storage unit 212 preferably stores information related to material constants of a variety of printed circuit boards, printed circuit board shape, rising edge characteristics of a signal, an electric resistivity and cross-sectional shape of a conductive pattern, a shape of an electronic component to be mounted on the printed circuit board, permissible voltage value range, net list defining a wiring line between components, and restrictive condition such as a minimum spacing between conductive patterns, etc. These pieces of information stored on the storage unit 212 are read under the control of a control unit 210, and a shape information determining unit 214 determines a position of an electronic component on a printed circuit board, and a layout of a pattern (S302 and S304 of FIG. 5). When this position information is determined, the printed circuit board, the components mounted on the printed circuit board, and a layout state of a conductive pattern between the components are displayed on screen of the display unit 224. Then, using information of line constants (or relative dielectric constant of the printed circuit board) stored on the storage unit 212, the control unit 210 calculates the line length L (referred to as a threshold distance) that accounts for the above-described transmission noise (S308). The value calculated beforehand may be stored on the storage unit 212.

Next, a distance calculator 216 calculates a distance of a conductive pattern between the components (S310). The distance of the conductive pattern is preferably a length along the conductive pattern. Alternatively, Manhattan length may be used in order to perform calculations at high speed. When the distance between the components is calculated, a determining unit 218 compares all the distances with the threshold distance L (S314). If all the distances are shorter than the threshold distance L (NO in S314), there is no need to consider the transmission noise. The process thus ends.

With YES in S314, a conductive pattern longer than the threshold distance L is displayed in a different color to discriminate that conductive pattern from the other conductive patterns (S316).

Next, a simulation unit 220 performs the simple simulation on the conductive pattern longer than the threshold distance L (S317). The determining unit 218 then determines, based on the simulation results, whether the voltage of the signal with the transmission noise superimposed thereon is higher than a permissible upper limit voltage (S318). If the voltage of the signal with the transmission noise is higher than the permissible upper limit voltage value (YES in S318), the conductive pattern is highlighted in S322. If it is determined in S318 that the simulation result is lower than the permissible upper limit voltage value (NO in S318), it is then determined whether the value of V(3τ) is lower than the permissible lower limit voltage value (S320). If the value of V(3τ) is lower than the permissible lower limit voltage value (YES in S320), the conductive pattern is highlighted (S322). If the value of V(3τ) is higher than the permissible lower limit voltage value (NO in S320), it is then determined in S324 whether all the conductive patterns longer than the threshold distance L have been checked as to whether each conductive pattern is out of the range of from the permissible upper limit voltage value to the permissible lower limit voltage value. If any unchecked pattern remains (NO in S324), processing returns again to S317.

If the checking as to whether each of the conductive patterns is out of the range of from the permissible upper limit voltage value to the permissible lower limit voltage value is completed on all the conductive patterns longer than the threshold distance L (YES in S324), processing ends.

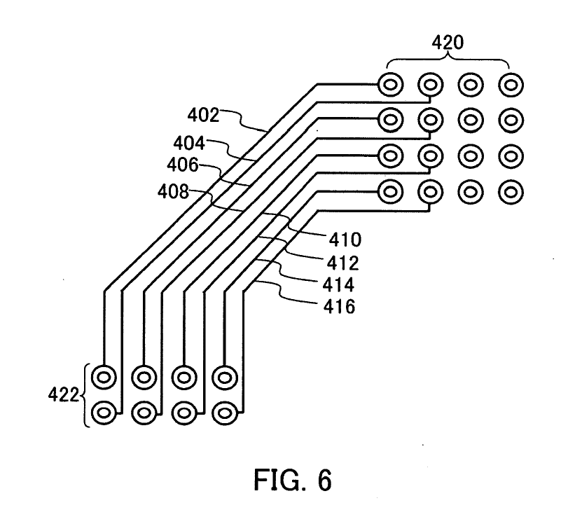

The highlighted display example is illustrated in FIG. 6. FIG. 6 illustrates part of the printed circuit board, including lands formed of a number of through-holes labeled 420, and lines formed of lands 420 and lands 422 connected by conductive patterns 402, . . . , 416. In this wiring, the conductive patterns 402, 404, 406, and 408 are longer than the threshold distance L and the conductive patterns 406 and 408 are out of the permissible voltage range. In accordance with the present embodiment, the conductive patterns 402 and 404 are highlighted in red and the conductive patterns 406 and 408 are blinked.

Since the highlight mode of the conductive patterns is thus changed in this way, a user can clearly recognize which condition the highlighted conductive pattern fails to satisfy.

The above-described process is executed by the control unit 210 itself or under the control of the control unit 210. In one configuration, a substantial portion of the above-described process may be executed by a CPU. Also, with a conductive pattern and a component selected using an input unit 222 such as a keyboard or a mouse, the threshold distance and the voltage value to be applied may be calculated. Furthermore, results of a simulation and a variety of calculations may be temporarily stored on a ROM, etc.

A conductive pattern having a threshold distance along which a transmission noise superimposes on a signal at the rise time of the signal is determined from among conductive patterns on a printed circuit board. That pattern is selected. A voltage applied to a component via the selected conductive pattern is simulated more in detail. Maximum and minimum application voltages are determined. A conductive pattern generating a transmission noise at a high speed and a component affected by the transmission noise are thus identified.

As described above, according to the apparatus or the method of the embodiment, instead of simulating all the lines, a line where the generation of transmission noise is highly likely is determined as to whether a signal having the transmission noise superimposed thereon is within a given value. Thus, the number of simulations is reduced, and the content of simulations is simplified.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alternations could be made hereto without departing from the spirit and scope of the invention.

What is claimed is:

1. An apparatus for designing a printed circuit board comprising:
a determining section for obtaining data of a distance along a conductive line between a electronic component and a signal source which are mounted on the printed circuit board, the signal source transmitting a signal to the electronic component;
a controller for obtaining data of a maximum distance for preventing a voltage across the electronic component in a steady state from being superimposed with a reflected signal reflected from at the signal source, the maximum distance being between the electronic component and the signal source, the voltage caused by the signal; and
a simulator for determining whether an amplitude of a voltage applying across the electronic component is within a given range when the distance is longer than the maximum distance.

2. The apparatus according to claim 1, further comprising a display for notifying the conductive line when the amplitude of the voltage is out of the given range.

3. An apparatus for designing a printed circuit board comprising:
a first determining section for determining positions of electronic components mounted on the printed circuit board and conductive line formed on the printed circuit board on the basis of data related to a circuit formed on the printed circuit board;
a controller for obtaining data of a condition of constraint for a distance between two of the electronic components on the basis of characteristic data of at least the printed circuit board and the electronic components;
a calculator for obtaining a distance along the conductive line between the electronic components the basis of the positions of the electronic components and the conductive line;
a second determining section for determining whether the distance satisfies the condition; and
a simulator means for obtaining data of an amplitude of a signal applied across the electronic component on the basis of positions of electronic components, the condition of constraint, and the distance when the distance is determined as being out of the condition.

4. The apparatus according to claim 3, further comprising a display for displaying distinctly each the conductive line being out of the condition of constraint in the conductive lines displayed.

5. The apparatus according to claim 3, wherein the distance is obtained by using of Manhattan distance.

6. A method for designing a printed circuit board comprising:
determining a distance along a conductive line between an electronic component and a signal source which are mounted on the printed circuit board, the signal source transmitting a signal to the electronic component;
calculating a maximum distance for preventing a voltage across the electronic component in a steady state from being superimposed with a reflected signal reflected from at the signal source, the maximum distance being between the electronic component and the signal source, the voltage caused by the signal; and
simulating whether an amplitude of a voltage applying across the electronic component is within a given range when the distance is longer than the maximum distance.

7. The method according to claim 6, further comprising notifying the conductive line when the amplitude of the voltage is out of the given range.
